(19) United States
(12) Patent Application Publication
(10) Pub. No.: US 2018/0165666 A1
(43) Pub. Date: Jun. 14, 2018

(54) SALES DATA PROCESSING APPARATUS AND METHOD

(71) Applicant: TOSHIBA TEC KABUSHIKI KAISHA, Tokyo (JP)

(72) Inventor: Akiko INOUE, Tagata Shizuoka (JP)

(21) Appl. No.: 15/833,654

(22) Filed: Dec. 6, 2017

(30) Foreign Application Priority Data
Dec. 8, 2016 (JP) 2016-238696

(51) Int. Cl. G06Q 20/20; G06Q 20/32; G06Q 20/34

(52) U.S. Cl. CPC G06Q 20/204; G06Q 20/34; G06Q 20/3278; G06Q 20/209

(57) ABSTRACT

A register apparatus according to an embodiment includes a code reader that optically reads a code on a commodity. A data reading and writing device charges electronic money with respect to an information storage medium that stores electronic money information. A processor identifies the commodity based on the code read by the code reader, and calculates a total amount of money due for purchase of each commodity identified. The processor calculates a difference between a payment amount and the total amount as change, when the payment amount paid in cash exceeds the total amount. A display device displays a first screen requesting a selection of one of cash and electronic money for receiving the change. The data reading and writing device charges at least a portion of the calculated change to an information storage medium that stores electronic money information when electronic money is selected via the first screen.

### CROSS-REFERENCE TO RELATED APPLICATION

This application is based upon and claims the benefit of priority from Japanese Patent Application No. 2016-238696, filed Dec. 8, 2016, the entire contents of which are incorporated herein by reference.

### FIELD

Embodiments described herein relate to a sales data processing apparatus and a method.

### BACKGROUND

Electronic settlement of a transaction may be based on information (electronic money information or the like) according to electronic money information stored in an information storage medium such as an electronic money card. In a store such as a supermarket, by using a sales data processing apparatus, it is possible to perform settlement of the transaction via electronic settlement based on the electronic money information or via cash settlement by cash.

However, even in the sales data processing apparatus used in the above-described store, there may be a desire to charge the change generated by the cash settlement as electronic money.

### DESCRIPTION OF THE DRAWINGS

FIG. 1 is a diagram illustrating a schematic configuration of a POS terminal according to an embodiment.

FIG. 2 is a diagram illustrating an example of a hardware configuration of the POS terminal.

FIG. 3 is a diagram illustrating an example of a functional configuration of the POS terminal.

FIG. 4 is a diagram illustrating an example of a selection screen.

FIG. 5 is a diagram illustrating an example of a receipt issued by a receipt issuing unit.

FIG. 6 is a diagram illustrating another example of a receipt issued by the receipt issuing unit.

FIG. 7 is a flowchart illustrating an example of a process performed by the POS terminal.

FIG. 8 is a diagram illustrating another example of the selection screen.

FIG. 9 is a diagram illustrating still another example of the selection screen.

### DETAILED DESCRIPTION

Embodiments provide a sales data processing apparatus and a method which can charge change generated in a cash settlement as electronic money.

A register apparatus (e.g., sales data processing apparatus) according to an embodiment includes a code reader that optically reads a code on a commodity. A data reading and writing device charges electronic money with respect to an information storage medium that stores electronic money information. A processor identifies the commodity based on the code read by the code reader, and calculates a total amount of money due for purchase of each commodity identified. The processor calculate a difference between a payment amount and the total amount as change, when the payment amount paid in cash exceeds the total amount, and controls a display device to display a first screen requesting a selection of one of cash and electronic money for receiving the calculated change. The data reading and writing device charges at least a portion of the calculated change to an information storage medium that stores electronic money information when electronic money is selected via the first screen.

Hereinafter, a sales data processing apparatus and a method according to an embodiment described herein will be described with reference to the drawings. In the following description, the sales data processing apparatus of the embodiment described herein is applied to a POS terminal which is installed in a store such as a supermarket or a convenience store and performs a registration process and a settlement process of a commodity.

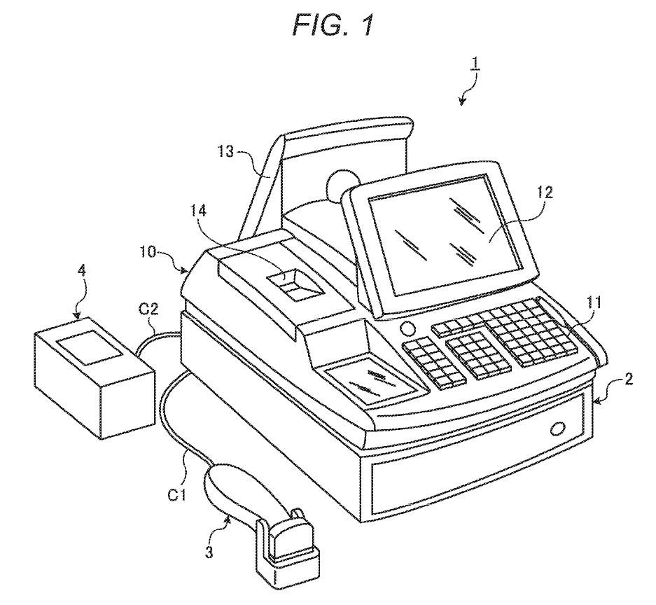

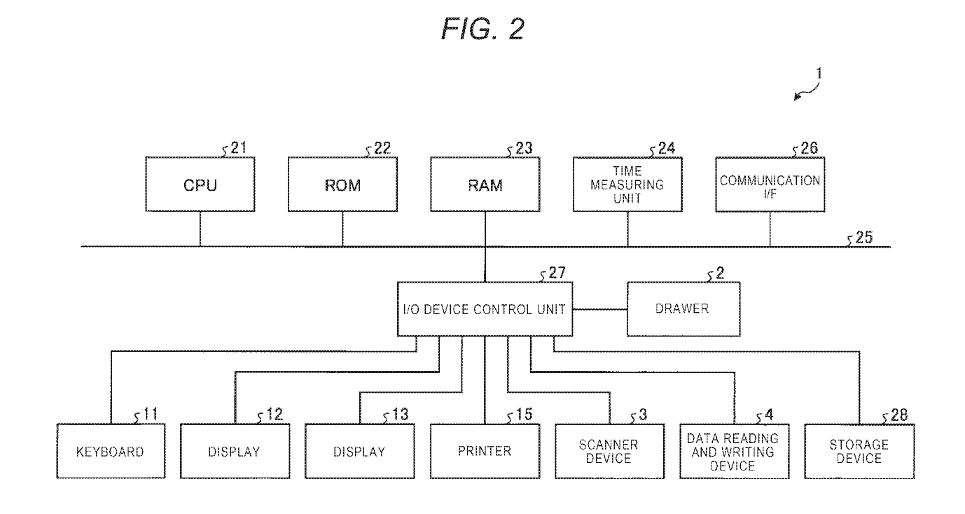

FIG. 1 is a diagram illustrating a schematic configuration of a POS terminal 1 according to the embodiment. As illustrated in FIG. 1, the POS terminal 1 is positioned on an upper surface of a drawer 2 that stores money. The POS terminal 1 is electrically connected to the drawer 2. The POS terminal 1 includes a keyboard 11, a salesperson display 12, a customer display 13, a receipt issuing port 14, and the like on an upper surface of the main body housing (housing) 10. In addition, the POS terminal 1 is connected to a hand-held scanner device 3 through a communication cable C1 so as to enable data communication. In addition, the POS terminal 1 is connected to a data reading and writing device 4 through a communication cable C2 so as to enable the data communication. In addition, the POS terminal 1 includes a printer 15 (see FIG. 2) that prints and issues a receipt and a journal, on a transaction basis. The printer 15 may be positioned inside the main body housing 10.

The display 12 and the display 13 are each a display device such as a liquid crystal display. The display 12 and the display 13 display various pieces of information based on the control of a central processing unit (CPU) 21 which will be described below. In addition, the display 12 and the display 13 are touch panel type display devices in which touch panels are overlaid on a display surface thereof. When an operation is performed through the touch panel, the display 12 and the display 13 output an operation signal corresponding to the operation to the CPU 21 which will be described below.

The scanner device 3 is a code reading device that reads code information such as a barcode attached to a commodity (not shown) to be purchased by a customer by a reading operation of a salesperson. The code information attached to the commodity is, for example, identification information for identifying the commodity.

The data reading and writing device 4 is a device for reading and writing electronic money information with respect to an information storage medium such as an electronic money card or a portable information terminal (for example, smartphone). Here, the electronic money information means information relating to electronic settlement such as money amount information indicating the amount of money to be charged. The data reading and writing device 4 may be a near field communication (NFC) device.

The POS terminal 1 specifies the commodity to be purchased by the customer and registers information relating to the commercial transaction of the commodity based on the commodity code read by the scanner device 3. When closing of the transaction is instructed, the POS terminal 1 performs the settlement process (cash settlement) in which settlement based on the amount of money of cash paid by the customer is performed on the total amount of each commodity registered so far. In addition, when the payment is performed with an electronic money, the POS terminal 1 performs the settlement process (electronic settlement) based on the electronic money information read in the data reading and writing device 4. In addition, the POS terminal 1 is configured to be able to charge the amount of money that is designated in the information storage medium through the data reading and writing device 4.

FIG. 2 is a diagram illustrating an example of a hardware configuration of the POS terminal 1. As illustrated in FIG. 2, the POS terminal 1 includes the CPU 21, a read only memory (ROM) 22, a random access memory (RAM) 23, and the like.

The CPU 21 is a processor, performs various calculations, and integrally controls each unit of the POS terminal 1. The ROM 22 stores various programs or various types of data. The RAM 23 temporarily stores various programs or stores the various types of data in a rewritable manner. In addition to the ROM 22 and the RAM 23, a time measuring unit 24 that measures a date and a communication interface (in drawing, communication I/F) 26 are connected to the CPU 21 through a bus 25. The POS terminal 1 can communicate with an external apparatus such as a host server through the communication interface 26.

In addition, a storage device 28, the keyboard 11, the display 12, the display 13, the printer 15, the drawer 2, the scanner device 3, and the data reading and writing device 4 which are described above are connected to the CPU 21 through the bus 25 and an I/O device control unit 27. With this configuration, the CPU 21 can control each unit. In addition, the CPU 21 can receive data from the keyboard 11, the scanner device 3, the data reading and writing device 4, and the like.

For example, the storage device 28 is configured with a hard disk drive device or the like. The storage device 28 stores a program, such as a settlement program, executed by the CPU 21, a commodity master file, a sales file that stores sales data, or the like. The commodity master file stores commodity information such as a commodity code, a commodity classification, a commodity name, and a unit price for identifying the commodity, with respect to each commodity.

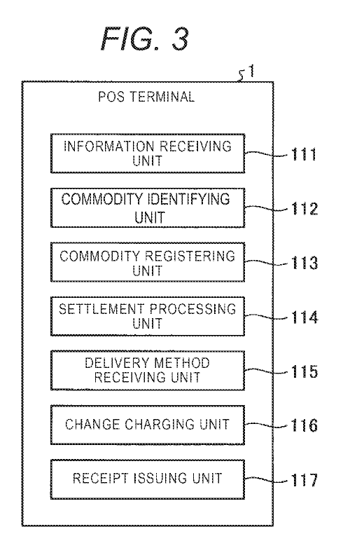

As illustrated in FIG. 3, the CPU 21 functions as an information receiving unit 111, a commodity identifying unit 112, a commodity registering unit 113, a settlement processing unit 114, a delivery method receiving unit 115, a change charging unit 116, a receipt issuing unit 117, and the like, by executing the settlement program stored in the ROM 22 or the storage device 28.

FIG. 3 is a diagram illustrating an example of a functional configuration of the POS terminal 1. The information receiving unit 111 is an example of information receiving means. The information receiving unit 111 receives the identification information for identifying various commodities. More specifically, the information receiving unit 111 receives the commodity code output from the scanner device 3.

The commodity identifying unit 112 represents the CPU 21 programmed to execute the following steps of the settlement program. The commodity identifying unit 112 is an example of specifying means. The commodity identifying unit 112 identifies the commodity based on the commodity code received by the information receiving unit 111. More specifically, when the commodity code is received from the scanner device 3, the commodity identifying unit 112 refers to the commodity master file, and identifies the commodity corresponding to the commodity code.

The commodity registering unit 113 represents the CPU 21 programmed to execute the following steps of the settlement program. The commodity registering unit 113 is an example of registering means or first calculating means. The commodity registering unit 113 registers the sales data according to the commercial transaction with respect to the commodity identified in the commodity identifying unit 112. More specifically, the commodity registering unit 113 obtains the commodity information of the identified commodity from the commodity master file, and sets the obtained commodity information as the sales data together with the number of commodities or the like received through the keyboard 11 or the like. The commodity registering unit 113 registers the sales data by storing the sales data in the RAM 23 or the like. In addition, the commodity registering unit 113 calculates the total amount based on the unit price of the commodity and the number of commodities. In addition, the commodity registering unit 113 displays the registered sales data, the calculated total amount, or the like on the display 12 or the display 13.

The settlement processing unit 114 represents the CPU 21 programmed to execute the following steps of the settlement program. The settlement processing unit 114 is an example of the first calculating means or second calculating means. When the closing of the transaction is instructed by an input of a settlement operation (for example, pressing of subtotal key (not shown) or the like) through the keyboard 11 or the like, the settlement processing unit 114 performs the settlement process of the commodity based on the total amount of the commodity (or commodities) in the transaction and the payment amount paid with cash or electronic money. In addition, when the payment amount paid by cash exceeds the total amount of the commodity, the settlement processing unit 114 calculates a difference amount therebetween as change.

The delivery method receiving unit 115 represents the CPU 21 programmed to execute the following steps of the settlement program. The delivery method receiving unit 115 is an example of receiving means. The delivery method receiving unit 115 receives selection of the cash or the electronic money and designates the selected delivery method, as a change delivery method of the change calculated by the settlement processing unit 114. Here, the selection of the delivery method may be performed by the customer, and may be performed by the salesperson. For example, when the selection of the delivery method is performed by the customer, the delivery method receiving unit 115 displays a selection screen for selecting the delivery method of the change on a customer display 13.

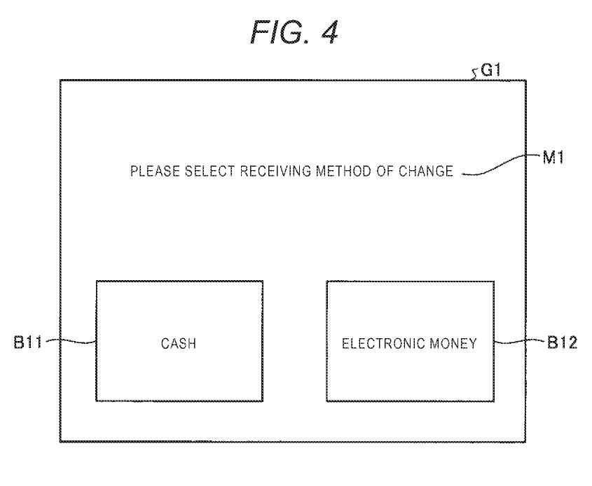

FIG. 4 is a diagram illustrating an example of the selection screen displayed by the delivery method receiving unit 115. As illustrated in FIG. 4, selection buttons B11 and B12 together with a message M1 urging the selection of the change delivery method is displayed on a selection screen G1. Here, the selection button B11 is for instructing cash delivery. When the selection button B11 is operated by a touch panel operation, the delivery method receiving unit 115 determines that the cash delivery method is selected. Meanwhile, the selection button B12 is for instructing the electronic money delivery method. When the selection button B12 is operated by a touch panel operation, the delivery method receiving unit 115 determines that the electronic money delivery method is selected.

In addition, when the selection of the delivery method is performed by the salesperson, the salesperson orally confirms the change delivery method to the customer and inputs the delivery method instructed from the customer through the keyboard 11 or the like. In this case, the delivery method receiving unit 115 receives the delivery method received through the keyboard 11 or the like. The delivery method receiving unit 115 may receive a selection input through the touch panel by displaying the above-described selection screen G1 on the salesperson display 12.

The change charging unit 116 represents the CPU 21 programmed to execute the following steps of the settlement program. The change charging unit 116 is an example of charging means. The change charging unit 116 charges an amount of money corresponding to the change to the information storage medium held by the customer, under a condition where the electronic money delivery method is designated. More specifically, the change charging unit 116 charges the amount of money corresponding to the change in the information storage medium placed in the data reading and writing device 4, by cooperating with the data reading and writing device 4. When the cash is designated as the delivery method, the salesperson takes out the amount of money equal to the change from the drawer 2, and hands the money to the customer.

The receipt issuing unit 117 represents the CPU 21 programmed to execute the following steps of the settlement program. The receipt issuing unit 117 is an example of issuing means. The receipt issuing unit 117 issues the receipt on which the content of the transaction is printed for each transaction. More specifically, the receipt issuing unit 117 prints the sales data, the total amount, the payment amount, the delivery method of the change, the change amount, or the like of the commodity registered by one transaction on the receipt, by cooperating with the printer 15. In addition, the receipt issuing unit 117 includes, on the receipt, a notation of the change delivery method according to the change delivery method of the change designated by the delivery method receiving unit 115.

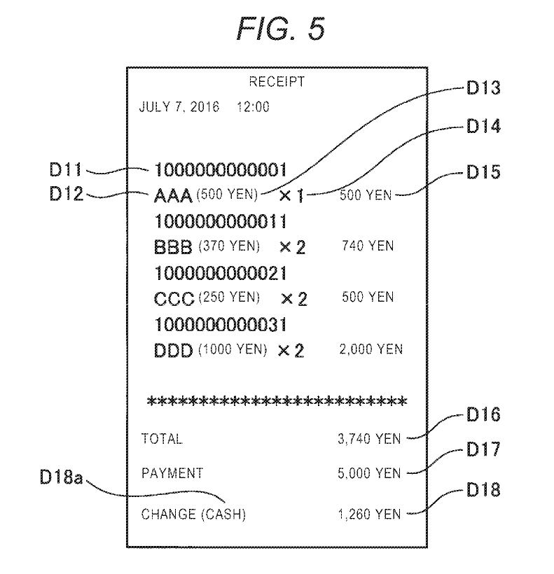

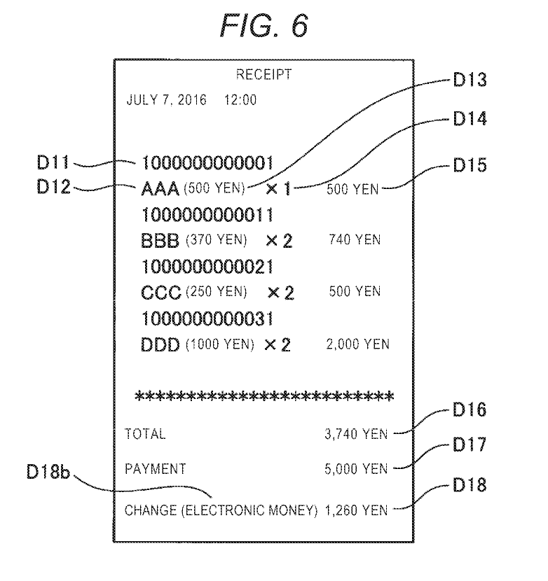

FIGS. 5 and 6 are diagrams illustrating examples of the receipt issued by the receipt issuing unit 117. Here, FIG. 5 illustrates the receipt of a case in which the cash is designated as the change delivery method. In addition, FIG. 6 illustrates the receipt of a case in which the electronic money is designated as the change delivery method.

As illustrated in FIGS. 5 and 6, the receipt includes a commodity code D11, a commodity name D12, a unit price D13, a number of pieces D14, an amount of money D15, a total amount D16, a payment amount D17, a change amount D18, or the like of each commodity registered in one transaction. Here, the change delivery method designated by the delivery method receiving unit 115 is printed on the change amount D18 in accordance with the method. For example, when the cash delivery is designated, as illustrated in FIG. 5, “cash” text D18a in accordance with the change amount D18 is printed. In addition, as illustrated in FIG. 6, when the electronic money delivery is designated, “electronic money” text D18b in accordance with the change amount D18 is printed.

As described above, it is possible for the receipt issuing unit 117 to improve convenience when the customer checks a location of the change by printing the change delivery method on the receipt. A form of the receipt is not limited to the examples of FIGS. 5 and 6. For example, the receipt issuing unit 117 may print a payment method (cash or electronic money) of the payment amount in accordance with the payment amount D17 on the receipt. In addition, when the electronic money is designated as the delivery method, the receipt issuing unit 117 may print a balance of the electronic money after the charge together with the delivery method on the receipt.

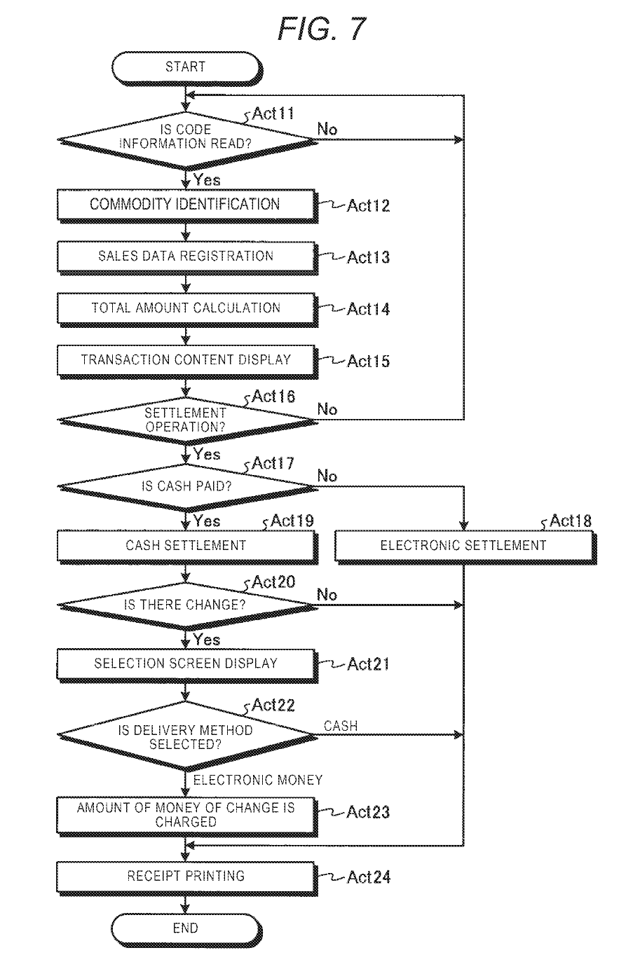

Next, an operation of the POS terminal 1 will be described with reference to FIG. 7. FIG. 7 is a flowchart representing an example of a process performed by the POS terminal 1.

First, the information receiving unit 111 waits until the code information attached to the commodity is read by the scanner device 3 (Act 11; No). When the code information is read by the scanner device 3 (Act 11; Yes), the information receiving unit 111 inputs the commodity code read in the reading to the commodity identifying unit 112.

The commodity identifying unit 112 refers to the commodity master file based on the commodity code that is input, and identifies the commodity corresponding to the commodity code (Act 12). The commodity registering unit 113 reads the commodity information such as the commodity code, the commodity name, and the unit price of the commodity identified in Act 12 from the commodity master file, and stores (registers) the read commodity information together with the number of commodities received through the keyboard 11 or the like in the RAM 23, as the sales data (Act 13). In addition, the commodity registering unit 113 calculates the total amount based on the unit price that is read and the number of commodities that is input, and stores the calculated result in the RAM 23 (Act 14). Next, the commodity registering unit 113 displays the commodity information, the total amount, or the like stored in the RAM 23 on the display 12 or the display 13, as transaction content (Act 15).

Processes of the above-described Acts 11 to 15 are repeated until there is an input of the settlement operation through the keyboard 11 or the like (Act 16; No).

When the closing of the transaction is instructed by the input of the settlement operation (Act 16; Yes), the settlement processing unit 114 waits until a payment method is selected. Here, when the electronic money—for which change is not generated—is selected as the payment method (Act 17; No), the settlement processing unit 114 electronically settles a price corresponding to the total amount stored in the RAM 23 (Act 18) based on the electronic money information read by the data reading and writing device 4, and the process thereof transitions to Act 24.

In addition, in Act 17, when the cash payment method is selected (Act 17; Yes), the settlement processing unit 114 settles the price corresponding to the total amount stored in the RAM 23 based on an amount of cash paid by the customer (Act 19). In addition, the settlement processing unit 114 compares the amount paid with cash to the total amount, and when the payment amount exceeds the total amount, the difference therebetween is calculated as change (Act 20; Yes). When the payment amount and the total amount are equal to each other and change is not required (Act 20; No), the process thereof transitions to Act 24.

The delivery method receiving unit 115 displays a selection screen (see FIG. 4) in which the delivery method of the change is selected on the display 12 or the display 13, under a condition in which the change is calculated in Act 20 (Act 21). Next, the delivery method receiving unit 115 waits until the change delivery method is selected (Act 22).

Here, when the cash is selected (Act 22; cash), the delivery method receiving unit 115 designates cash as the change delivery method, and the process thereof transitions to Act 24. When cash is selected, the salesperson hands the cash corresponding to the change amount to the customer.

Meanwhile, in Act 22, when the electronic money is selected (Act 22; electronic money), the delivery method receiving unit 115 designates the electronic money as the change delivery method.

The change charging unit 116 operates the data reading and writing device 4 when the electronic money is designated as the change delivery method. Then, the change charging unit 116 charges the amount of money of change in the information storage medium by cooperating with the data reading and writing device 4 (Act 23), and the process thereof transitions to Act 24.

Subsequently, the receipt issuing unit 117 issues the receipt on which the content of the transaction is printed by cooperating with the printer 15 (Act 24), and the process is completed. The receipt issuing unit 117 changes the notation of the delivery method printed on the receipt according to the change delivery method designated by the delivery method receiving unit 115.

As described above, when change is generated in the cash settlement, the POS terminal 1 selects cash or electronic money as the change delivery method to the customer or the salesperson. Then, when the electronic money is selected as the change delivery method, the POS terminal 1 charges the amount of money of change to the information storage medium as the electronic money. With this, the POS terminal 1 can charge the change amount generated in the cash settlement as electronic money in a series of processes according to the purchase of the commodity. In addition, by delivering the electronic money corresponding to change generated in the cash settlement, it is unnecessary to give and receive the change in the cash. Accordingly, it is possible to improve the convenience of the customer with respect to the giving and reception of the cash, and it is possible to improve the efficiency of the transaction. In addition, since the customer can increase the amount of electronic money with a sense of savings every time the transaction is performed, it is possible to promote additional purchases.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

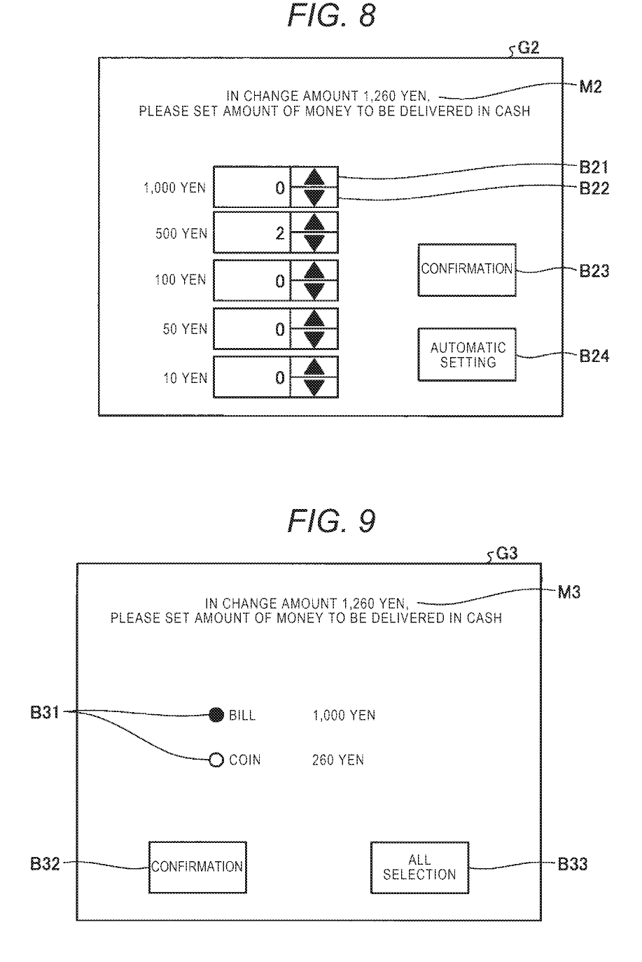

For example, in the embodiment, an example in which all change is delivered in cash or electronic money is described. However, the embodiment is not limited thereto, and a configuration may be implemented so that a part of change is delivered as cash and the remaining amount is delivered as electronic money. In this case, for example, the delivery method receiving unit 115 may receive the amount of money to be delivered in cash in specific denominations of bills and coins by displaying the selection screen illustrated in FIGS. 8 and 9 on the display 12 or the display 13.

FIG. 8 is a diagram illustrating another example of the selection screen displayed by the delivery method receiving unit 115. The selection screen G2 displays selectable amounts of denominations of money together with a message M2 requesting setting of the denominations of money to be delivered as change. In FIG. 8, a screen example of a case where 1,260 Yen is to be delivered as change is illustrated, and denominations of 1,000 Yen, 500 Yen, 100 Yen, 50 Yen, and 10 Yen are displayed.

Here, each denomination of money displayed on the selection screen G2 can be set as a number equal to or greater than zero by an operation of an up button B21 or a down button B22. Specifically, every time the up button B21 is operated (pressed) once, the denomination is incremented by one, and every time the down button B22 is operated (pressed) once, the denomination is decremented by one. It is assumed that the total amount calculated by a combination of the selected amount of each denomination and the value of each denomination is controlled to be equal to or less than the change amount. In addition, the total amount calculated by the combination of the selected amount of each denomination, the value of each denomination and a value (amount of money corresponding to charged amount) obtained by subtracting the total amount from the selected amount of change may be displayed on the selection screen G2.

In addition, a confirmation button B23 is provided in the selection screen G2. When an operation of the confirmation button B23 is accepted, the delivery method receiving unit 115 calculates the total amount based on the selected number of each denomination of money that is set. Accordingly, the delivery method receiving unit 115 designates the calculated total amount as the amount of money (cash change amount) of the change to be delivered in cash. In addition, the delivery method receiving unit 115 designates the remaining amount of money obtained by subtracting the cash change amount from the change to be delivered as the amount of change (charge change amount) to be delivered as electronic money. In this case, the salesperson delivers cash corresponding to the cash change amount to the customer based on the selected number of each denomination which is set in the selection screen G2.

In addition, an automatic setting button B24 is provided in the selection screen G2. When an operation of the automatic setting button B24 is accepted, the delivery method receiving unit 115 automatically sets the amount of each denomination corresponding to the amount of change, and designates to deliver the amount of change in cash. In this case, it is preferable that the delivery method receiving unit 115 set the amount of each denomination so as to reduce the amount of the bills and the coins to be delivered to each part.

FIG. 8 illustrates an example where the setting of amount of each denomination is accepted for the cash delivery method. However, the embodiment is not limited thereto. Even in the electronic money delivery method, a configuration where the setting of amount of each denomination is similarly accepted may be implemented.

In addition, FIG. 9 is a diagram illustrating still another example of the selection screen displayed by the delivery method receiving unit 115. The amount of change together with a message M3 urging a setting corresponding to the amount of each denomination to be delivered in cash is displayed in a selection screen G3 on units of bills and coins. FIG. 9 illustrates a screen example of a case where change corresponding to 1,260 Yen is delivered, and 1,000 Yen as the amount of money corresponding to the bills and 260 Yen as the amount of money corresponding to the coins are displayed.

Here, the amount of money corresponding to the bills and the amount of money corresponding to the coins displayed on the selection screen G3 are each able to be switched between valid and invalid by a toggle operation of a check button B31. For example, when the check button B31 is operated (pressed) once in an invalid state, the state changes to a valid state, and when the check button B31 is operated (pressed) once in a valid state, the state changes to an invalid state.

In addition, a confirmation button B32 is provided in the selection screen G3. When an operation of the confirmation button B32 is accepted, the delivery method receiving unit 115 designates a total value of the amount of money of the bills and the coins which are validated as the change amount (cash change amount) to be delivered in cash. In addition, the delivery method receiving unit 115 designates a total value of the amount of money of the bills and the coins which are not in the valid state as the amount of money (charge change amount) of change to be delivered as electronic money. It is assumed that the salesperson delivers the cash corresponding to the cash change amount based on the bills and the coins which are in the valid state to the customer.

In addition, an all selection button B33 is provided in the selection screen G3. When an operation of the all selection button B33 is accepted, the delivery method receiving unit 115 sets the bills and the coins to the valid state, and designates to deliver the total amount of change in cash.

With the above configuration, the customer can instruct the amount of money to be received in cash in the amount and denominations of bills and coins, and can charge the remaining money as electronic money. Accordingly, it is possible for the POS terminal 1 to improve the convenience of the customer with respect to giving and reception of change, and can increase the opportunity of charging to electronic money. It is assumed that when the above configuration is adopted, the receipt issuing unit 117 prints the notation of the delivery method and the amount of money delivered by cash and electronic money on the receipt.

In addition, in the embodiment, when the cash is designated as the change delivery method, the amount of change is handed to the customer by an operation of the salesperson. However, the settlement processing unit 114 or the like may support the operation. For example, the settlement processing unit 114 may display a message instructing to deliver the change in cash on the display 12 when cash is designated as the change delivery method. In addition, the settlement processing unit 114 may support taking out change by controlling the drawer 2 to open when cash is designated as the change delivery method. In addition, a configuration where when an automatic change dispenser that automatically pays change by cash may be provided in the POS terminal 1. In such a configuration, the settlement processing unit 114 pays cash corresponding to the change by cooperating with the automatic change dispenser when cash is designated as the change delivery method.

In addition, in the embodiment, it is described that the change generated in the cash settlement is charged as electronic money. However, the change generated at the time of the electronic settlement may be similarly processed. Specifically, when the charged amount of money held in the information storage medium is less than the total amount of the commodity, a shortage amount may be paid in cash. In such a case, when the amount of money paid in the cash exceeds the shortage amount, since change is required, the delivery method of the change may be selected in the same manner as described above.

In addition, in the embodiment, a type of the POS terminal 1 in which the salesperson performs a registration operation and a settlement operation of the commodity as the sales data processing apparatus is used as an application example. However, the embodiment may be applied to another type sales data processing apparatus. For example, the embodiment may be applied to a semi-self-service type sales data processing apparatus (settlement apparatus) in which the customer himself/herself performs an operation according to the settlement of the commodity registered in a registration apparatus and a type of the sales data processing apparatus in which the customer himself/herself performs the registration operation and the settlement operation of the commodity.

In addition, it is assumed that a program executed in each apparatus of the embodiment is provided by incorporating in advance in a storage medium (ROM or storage unit) included in each apparatus. However, the embodiment is not limited thereto. A configuration where the program is provided by recording the program in a computer readable recording medium such as a CD-ROM, a flexible disk (FD), a CD-R, and a digital versatile disk (DVD), as a file of an installable format or executable format, may be implemented. Furthermore, the storage medium is not limited to a computer or a medium independent from an embedded system. However, the storage medium also includes a storage medium in which a program transmitted through a LAN, the Internet, or the like is stored or temporarily stored by downloading.

In addition, a configuration where the program executed in each apparatus of the embodiment is provided by being stored on a computer connected to a network such as the Internet and downloaded through the network, or provided or distributed through the network such as the Internet, may be implemented.

What is claimed is:

1. A register apparatus comprising:
code reader configured to optically read a code on a commodity;
a data reading and writing device configured to charge electronic money with respect to an information storage medium that stores electronic money information;
a display; and
a processor configured to:
identify the commodity based on the code read by the code reader,
calculate a total amount of money due for purchase of each commodity identified,
calculate a difference between a payment amount and the total amount as change, when the payment amount paid in cash exceeds the total amount,
control the display to display a first screen requesting a selection of one of cash and electronic money for receiving the calculated change, and
control the data reading and writing device to charge at least a portion of the calculated change to an information storage medium that stores electronic money information when electronic money is selected via the first screen.

2. The apparatus according to claim 1, wherein the processor is further configured to:
control the display to display a second screen requesting a selection of a number of each of a plurality of denominations of cash totaling no more than the calculated change amount, when cash is selected via the first screen.

3. The apparatus according to claim 2, wherein:
the second screen includes a selectable automatic currency setting button, and
when the automatic currency setting button is selected, the processor sets an amount of each denomination of cash to total the calculated change amount.

4. The apparatus according to claim 3, wherein the amount of each denomination of cash is set so that the total number of currency to be received is minimized.

5. The apparatus according to claim 2,
when the selected denominations of cash has a total value less than the calculated change amount, the processor controls the data reading and writing device to charge an amount equal to the difference between the calculated change amount and the total value to the information storage medium.

6. The apparatus according to claim 1, wherein the processor is further configured to:
control the display to display a third screen requesting a selection of any of bills and coins for receiving the calculated change when cash is selected via the first screen, and
when bills is selected and coins is not selected via the third screen, control the data reading and writing device to charge only the amount of the calculated change corresponding to coins to the information storage medium.

7. The apparatus according to claim 1, further comprising:
a printer configured to print a receipt including information indicating whether cash or electronic money was selected for receiving the calculated change amount.

8. The apparatus according to claim 1, wherein the data reading and writing device is configured to charge electronic money to a smartphone.

9. The apparatus according to claim 1, wherein the data reading and writing device is configured to charge electronic money to an electronic money card.

10. A method of controlling a register apparatus that includes a code reader, a display, and a data reading and writing device, the method comprising:
optically reading, with the code reader, a code on a commodity;
identifying the commodity based on the code read by the code reader;
calculating a total amount of money due for purchase of each commodity identified;
calculating a difference between a payment amount and the total amount as change, when the payment amount paid in cash exceeds the total amount;
controlling the display to display a first screen requesting a selection of one of cash and electronic money for receiving the calculated change; and
controlling the data reading and writing device to charge at least a portion of the calculated change to an information storage medium that stores electronic money information when electronic money is selected via the first screen.

11. The method according to claim 10, further comprising:
controlling the display to display a second screen requesting a selection of a number of each of a plurality of denominations of cash totaling no more than the calculated change amount, when cash is selected via the first screen.

12. The method according to claim 11, wherein the second screen includes a selectable automatic currency setting button, the method further comprising:
when the automatic currency setting button is selected, setting an amount of each denomination of cash to total the calculated change amount.

13. The method according to claim 12, wherein the amount of each denomination of cash is set so that the total number of currency to be received is minimized.

14. The method according to claim 11, wherein, when the selected denominations of cash has a total value less than the calculated change amount, the data reading and writing device is controlled to charge an amount equal to the difference between the calculated change amount and the total value to the information storage medium.

15. The method according to claim 10, further comprising:
controlling the display to display a third screen requesting a selection of any of bills and coins for receiving the calculated change when cash is selected via the first screen; and
when bills is selected and coins is not selected via the third screen, controlling the data reading and writing device to charge only the amount of the calculated change corresponding to coins to the information storage medium.

16. The method according to claim 10, further comprising:
controlling a printer to print a receipt including information indicating whether cash or electronic money was selected for receiving the calculated change amount.

17. The method according to claim 10, wherein the data reading and writing device is configured to charge electronic money to a smartphone.

18. The method according to claim 10, wherein the data reading and writing device is configured to charge electronic money to an electronic money card.
